(19) United States
(12) Patent Application Publication
(10) Pub. No.: US 2026/0282154 A1
(43) Pub. Date: Sep. 17, 2026

(54) MOBILE TERMINATED-SMALL DATA TRANSMISSION

(71) Applicant: NOKIA SOLUTIONS AND NETWORKS OY, Espoo (FI)

(72) Inventors: Samuli Heikki TURTINEN, Oulu (FI); Jussi-Pekka KOSKINEN, Oulu (FI); Chunli WU, Beijing (CN)

(21) Appl. No.: 19/472,294

(22) PCT Filed: Apr. 6, 2023
(86) PCT No.: PCT/CN2023/086694

§ 371 Date: Oct. 3, 2025

(51) Int. Cl. H04W 76/27; H04W 72/231; H04W 72/542

(52) U.S. Cl. CPC H04W 76/27; H04W 72/231; H04W 72/542

(57) ABSTRACT

According to some example embodiments of the present disclosure, there is provided a solution for mobile terminated small data transmission (MT-SDT). In the solution, the RRC entity indicates to the MAC entity of first information associated with a MT-SDT procedure. Based on the first information, the MAC entity checks one or more conditions related to initialization of the MT-SDT procedure. The MAC entity indicates to the RRC entity of second information, and the second information is related to a result of the condition checking. Based on the second information, the RRC entity may determine whether to initiate the MT-SDT procedure.

### FIELDS

Various example embodiments of the present disclosure generally relate to the field of telecommunication and in particular, to methods, apparatuses and computer readable storage medium for a Mobile Terminated-Small Data Transmission (MT-SDT).

### BACKGROUND

With developments of communication systems, new technologies have been proposed. For example, small data transmission (SDT) has been proposed. Specifically, the SDT is a transmission for a short data burst in a connectionless state where a terminal device (for example, user equipment, UE) does not need to establish and teardown connections when small amounts of data need to be sent. In addition to a Mobile Originated SDT (MO-SDT), an MT-SDT is also proposed. Therefore, it is worth studying on the MT-SDT.

### SUMMARY

In a first aspect of the present disclosure, there is provided an apparatus. The apparatus comprises at least one processor; and at least one memory storing instructions that, when executed by the at least one processor, cause the apparatus at least to perform: indicating, by a radio resource control (RRC) entity of the apparatus to a medium access control (MAC) entity of the apparatus, first information associated with a MT-SDT procedure; determining, by the MAC entity, whether one or more conditions related to initiation of the MT-SDT procedure are fulfilled based on the first information; indicating, by the MAC entity to the RRC entity, second information based on the determination; and determining, by the RRC entity, whether to initiate the MT-SDT procedure based on the second information.

In a second aspect of the present disclosure, there is provided a method. The method comprises: indicating, by a RRC entity of a terminal device to a MAC entity of the terminal device, first information associated with a MT-SDT procedure; determining, by the MAC entity, whether one or more conditions related to initiation of the MT-SDT procedure are fulfilled based on the first information; indicating, by the MAC entity to the RRC entity, second information based on the determination; and determining, by the RRC entity, whether to initiate the MT-SDT procedure based on the second information.

In a third aspect of the present disclosure, there is provided an apparatus. The apparatus comprises means for indicating, by a RRC entity of the apparatus to a MAC entity of the apparatus, first information associated with a MT-SDT procedure; means for determining, by the MAC entity, whether one or more conditions related to initiation of the MT-SDT procedure are fulfilled based on the first information; means for indicating, by the MAC entity to the RRC entity, second information based on the determination; and means for determining, by the RRC entity, whether to initiate the MT-SDT procedure based on the second information.

In a fourth aspect of the present disclosure, there is provided a computer readable medium. The computer readable medium comprises instructions stored thereon for causing an apparatus to perform at least the method according to the second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2A to FIG. 2C illustrate examples of signaling charts for SDT;

FIG. 3 illustrates a signaling chart for communication according to some example embodiments of the present disclosure;

FIG. 4 illustrates a flowchart of a method implemented at a terminal device according to some example embodiments of the present disclosure;

FIG. 5 illustrates a simplified block diagram of a device that is suitable for implementing example embodiments of the present disclosure; and

FIG. 6 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second”, . . . etc. in front of noun(s) and the like may be used herein to describe various elements, these elements should not be limited by these terms. These terms are only used to distinguish one element from another and they do not limit the order of the nouns. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “SDT” may refer to a procedure allowing data and/or signalling transmission while remaining in RRC_INACTIVE state (i.e., without transitioning to RRC_CONNECTED state). Specifically, the SDT is a transmission for a short data burst in a connectionless state where a device does not need to establish and teardown connections when small amounts of data need to be sent.

As used herein, the term “common random access (RA)” may refer to random access which is not dedicated to SDT. Similarly, the term “common random access channel (RACH)” or “common RA resource” may refer to RACH or RA resource which is not dedicated to SDT, respectively.

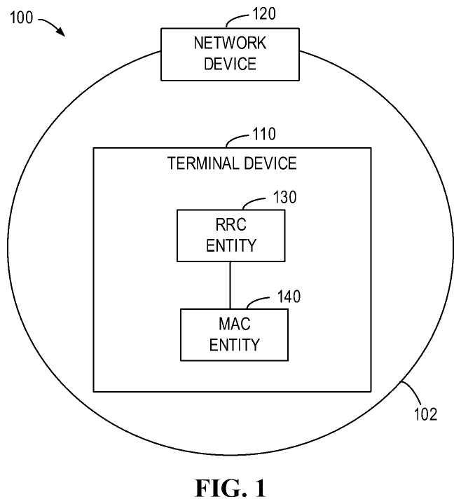

FIG. 1 illustrates an example communication environment 100 in which example embodiments of the present disclosure can be implemented. The communication environment 100 may include a terminal device 110. Hereinafter the terminal device 110 may also be referred to as a UE.

The terminal device 110 may include or implement entities for different layers. As shown in FIG. 1, the terminal device 110 may include a RRC entity 130 and a medium access control (MAC) entity 140. The RRC entity 130 and MAC entity 140 can interact with each other. In addition, one or more RRC entities may be located at a RRC layer and one or more MAC entities may be located at a MAC layer. In the following, the terms “RRC entity” and “RRC layer” can be used interchangeably, and the terms “MAC entity” and “MAC layer” can be used interchangeably, if there is no specific definition about the terms in the description.

The communication environment 100 may further include a network device 120. Hereinafter the network device 120 may also be referred to as a gNB. The network device 120 may communicate with the terminal device 110.

It is to be understood that the number of network devices, terminal devices and entities shown in FIG. 1 is given for the purpose of illustration without suggesting any limitations. The communication environment 100 may include any suitable number of network devices, terminal devices, and entities.

In some example embodiments, links from the network device 120 to the terminal device 110 may be referred to as a downlink (DL), while links from the terminal device 110 to the network device 120 may be referred to as an uplink (UL). In DL, the network device 120 is a transmitting (TX) device (or a transmitter) and the terminal device 110 is a receiving (RX) device (or receiver). In UL, the terminal device 110 is a TX device (or transmitter) and the network device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

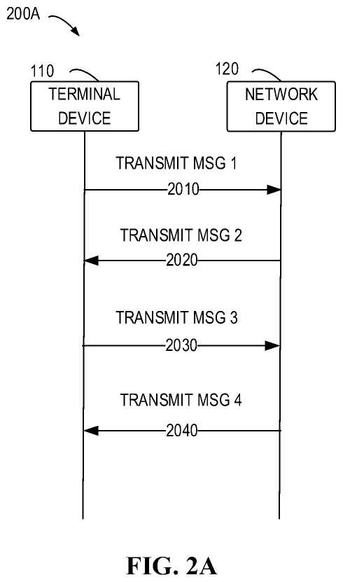

SDT can be applied to the communication environment 100. For example, the MT-SDT and the MO-SDT may be applied to the communication environment 100. MO-SDT is enabled on a radio bearer basis and is initiated by the terminal device only if less than a configured amount of UL data awaits transmission across all radio bearers for which SDT is enabled, the DL reference signal received power (RSRP) is above a configured threshold, and a valid SDT resource is available. FIG. 2A to FIG. 2C illustrate examples of signaling charts for SDT that can be applied in the communication environment 100.

FIG. 2A shows a signaling chart 200A of interactions for 4-step random access channel (RACH) based SDT (i.e., 4-step RA-SDT). As shown in FIG. 2A, the terminal device 110 can transmit (2010) a message 1 (MSG 1) to the network device 120 when the terminal device 110 is in a radio resource control (RRC) inactive state. The MSG 1 comprises a preamble for the RACH. The network device 120 can transmit (2020) a message 2 (MSG 2) to the terminal device 110. The MSG 2 comprises a random access response. The terminal device 110 can transmit (2030) a message 3 (MSG 3) to the network device 120. The MSG 3 comprises a RRC connection resume request. A small payload (i.e., the small data) can be transmitted in the MSG 3. For example, the small payload can be multiplexed with the RRC connection resume request. The network device 120 can transmit (2040) a RRC release message. FIG. 2B shows a signaling chart 200B of interactions for 2-step RACH based SDT (i.e., 2-step RA-SDT). As shown in FIG. 2B, when the terminal device 110 is in the RRC inactive state, the terminal device 110 may transmit (2110) a message A (MSG A) to the network device 120. The MSG A can comprise a preamble for the RACH. The small data can be transmitted with the MSG A. In particular, the small data can be transmitted on physical uplink shared channel (PUSCH) resources that are pre-configured by the network device 120 and are broadcasted in system information with associated physical transmission parameters. The network device 120 may transmit (2120) a message B (MSG B) to the terminal device 110. The MSG B comprises a random access response. FIG. 2C shows a signaling chart 200C of interactions for Configured Grant based SDT (i.e., CG-SDT). When the terminal device 110 is in a RRC Connected state, the terminal device 110 can receive (2210) a CG typel configuration that indicates specific pre-configured PUSCH resources to be used for UL data transmission in RRC inactive as long as the timing alignment is valid. The network device 120 can transmit (2220) a RRC release message.

The MO-SDT for new radio (NR) has been specified. SDT is a procedure allowing data and/or signalling transmission while remaining in RRC_INACTIVE state (i.e. without transitioning to RRC_CONNECTED state). SDT is enabled on a radio bearer basis and is initiated by the UE only if less than a configured amount of UL data awaits transmission across all radio bearers for which SDT is enabled, the DL RSRP is above a configured threshold, and a valid SDT resource is available.

SDT procedure is initiated with either a transmission over RACH (configured via system information) or over Type 1 CG resources (configured via dedicated signalling in RRCRelease or the other RRC message or information element, IE). The SDT resources can be configured on initial bandwidth part (BWP) for both RACH and CG. RACH and CG resources for SDT can be configured on either or both of non-supplementary uplink (NUL) and supplementary uplink (SUL) carriers. The CG resources for SDT are valid only within the primary cell (PCell) of the UE when the RRCRelease with suspend indication is received. CG resources are associated with one or multiple SSB(s). For RACH, the network can configure 2-step and/or 4-step RA resources for SDT. When both 2-step and 4-step RA resources for SDT are configured, the UE selects the RA type. Contention free random access (CFRA) is not supported for SDT over RACH.

Once initiated, the SDT procedure is either:
successfully completed after the UE is directed to RRC_IDLE (via RRCRelease) or to continue in RRC_INACTIVE (via RRCRelease or RRCReject) or to RRC_CONNECTED (via RRCResume or RRCSetup); or
unsuccessfully completed upon cell re-selection, expiry of the SDT failure detection timer, a MAC entity reaching a configured maximum PRACH preamble transmission threshold, an RLC entity reaching a configured maximum retransmission threshold, or expiry of SDT-specific timing alignment timer while SDT procedure is ongoing over CG and the UE has not received a response from the network after the initial PUSCH transmission.

Upon unsuccessful completion of the SDT Procedure, the UE transitions to RRC_IDLE.

The initial PUSCH transmission during the SDT procedure includes at least the common control channel (CCCH) message. When using CG resources for initial SDT transmission, the UE can perform autonomous retransmission of the initial transmission if the UE does not receive confirmation from the network (dynamic UL grant or DL assignment) before a configured timer expires. After the initial PUSCH transmission, subsequent transmissions are handled differently depending on the type of resource used to initiate the SDT procedure:
When using CG resources, the network can schedule subsequent UL transmissions using dynamic grants or they can take place on the following CG resource occasions. The DL transmissions are scheduled using dynamic assignments. The UE can initiate subsequent UL transmission only after reception of confirmation (dynamic UL grant or DL assignment) for the initial PUSCH transmission from the network. For subsequent UL transmission, the UE cannot initiate re-transmission over a CG resource.
When using RACH resources, the network can schedule subsequent UL and DL transmissions using dynamic UL grants and DL assignments, respectively, after the completion of the RA procedure.

While the SDT procedure is ongoing, if data appears in a buffer of any radio bearer not enabled for SDT, the UE initiates a transmission of a non-SDT data arrival indication using UEAssistanceInformation message to the network and, if available, includes the resume cause.

SDT procedure over CG resources can only be initiated with valid UL timing alignment. The UL timing alignment is maintained by the UE based on a SDT-specific timing alignment timer configured by the network via dedicated signalling and, for initial CG-SDT transmission, also by DL RSRP of configured number of highest ranked SSBs which are above a configured RSRP threshold. Upon expiry of the SDT-specific timing alignment timer, the CG resources are released while maintaining the CG resource configuration.

Logical channel restrictions configured by the network while in RRC_CONNECTED state and/or in RRCRelease message for radio bearers enabled for SDT, if any, are applied by the UE during SDT procedure.

The network may configure UE to apply robust header compression (ROHC) continuity for SDT either when the UE initiates SDT in the PCell of the UE when the RRCRelease with suspend indication was received or when the UE initiates SDT in a cell of its radio notification area (RNA).

The above-mentioned aspects are related to the MO-SDT. Currently, studies on the MT-SDT for NR are undergoing. For example, Release (Rel)-17 specified MO-SDT to allow small packet transmission for UL-oriented packets. For DL, MT-SDT (i.e. DL-triggered small data) allows similar benefits, i.e. 1) reducing signalling overhead and UE power consumption by not transitioning to RRC_CONNECTED and reducing latency by allowing fast transmission of (small and infrequent) packets, e.g. for positioning.

An objective is to specify the support for paging-triggered SDT (i.e., MT-SDT), including MT-SDT triggering mechanism for UEs in RRC_INACTIVE, supporting RA-SDT and CG-SDT as the UL response; MT-SDT procedure for initial DL data reception and subsequent UL/DL data transmissions in RRC_INACTIVE.

Regarding the MT-SDT, some agreements have been achieved. For RAN paging, MT-SDT indication (at least one bit) is explicitly included per UE via a paging message. In some example embodiments, Rel-18 MT-SDT after the MT-SDT paging trigger is detected, RA-SDT and CG SDT solutions/procedures specified in Rel-17 is re-used as a baseline. UE can use non-SDT random access resources for accessing the network for an MT-SDT transfer. UE can also use the configured grant resources and/or MO-RA resources. The network should be able to differentiate why the UL access was triggered, i.e. implicit or explicit indication by the UE. MT-SDT is data that belongs to bearers that are configured for SDT. The configuration may be MO-SDT or MT-SDT specific. The network can only trigger MT-SDT if the data belongs to those bearers. It is possible for the network to configure only MT-SDT without MO-SDT RA resources and/or CG-SDT. Subsequent UL/DL data belonging to SDT bearers while in INACTIVE is allowed like MO-SDT procedure. New Resume cause in RRC resume may be introduced, one code point MT-SDT indication.

Moreover, a one-bit indication may be included in paging to trigger MT-SDT. It is ensured that the common control channel (CCCH) message can be transmitted over CG. Indication may be per UE. In case condition for paging triggered MT-SDT is not fulfilled, the UE initiates RRC Resume procedure.

When UE resumes for MT-SDT, UE resumes all radio bears (RBs) configured for SDT. RBs configured for SDT are common for MO-SDT and MT-SDT. If there is valid CG-SDT resources, the UE should use CG-SDT to transmit the response. When SDT is initiated due to MT-SDT, UE can exchange subsequent DL/UL SDT data on the resumed RBs.

A RRC procedure for RRC Resume for MT-SDT initiation without checking for availability of UL data (i.e., if MT-SDT is initiated first the resume cause will be set to MT-SDT) needs to be specified. UE may be allowed to initiate either MO-SDT based resume or non-SDT based resume at any point (before initiation RRCResumeRequest for MT-SDT) using separate procedures. If MT-SDT procedure is initiated, for RACH during subsequent data transfer (i.e., RACH triggered due to scheduling request), UE may use only the non-SDT RACH resources (i.e., like legacy).

Given the above, it seems that MO-SDT-RA resources might not be used for MT-SDT since for MT-SDT initiation the UE will not check the availability of UL data. However, UE is able to trigger MO-SDT in case it has UL data in the buffer and, hence, naturally in that case use the MO-SDT-RA resources as well. Thus, MT-SDT based on RACH will use the common RACH which is not dedicated to SDT.

For MO-SDT, the MAC layer just indicates that the SDT procedure can be initiated from MAC point of view without providing any information about the SDT resources that are valid for use by SDT. If the MT-SDT procedure shall not use the MO-SDT RACH resources, such principle does not work for MT-SDT. Some solutions do not take the nature of the MT-SDT into account where the RA-SDT could not be used by MT-SDT nor that common RACH would be used for MT-SDT.

According to some example embodiments of the present disclosure, there is provided a solution for MT-SDT. In the solution, the RRC entity indicates to the MAC entity of first information associated with a MT-SDT procedure. Based on the first information, the MAC entity checks one or more conditions related to initialization of the MT-SDT procedure. The MAC entity indicates to the RRC entity of second information, and the second information is related to a result of the condition checking. Based on the second information, the RRC entity may determine whether to initiate the MT-SDT procedure. In this way, the interactions between the RRC and MAC layers are specified to support the MT-SDT.

Example embodiments of the present disclosure will be described in detail below with reference to the accompanying drawings.

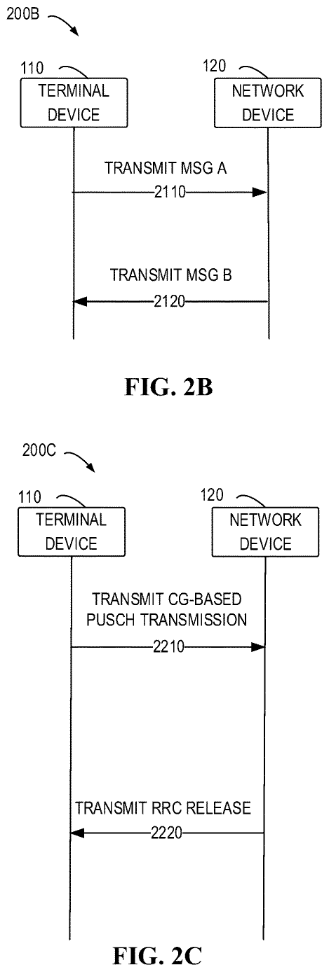

Reference is now made to FIG. 3, which shows a signaling chart 300 for communication according to some example embodiments of the present disclosure. As shown in FIG. 3, the signaling chart 300 involves the terminal device 110 and the network device 120. For the purpose of discussion, reference is made to FIG. 1 to describe the signaling chart 300.

In some example embodiments, the terminal device 110 may receive (305) an SDT configuration from the network device 120. For example, the SDT configuration may include a RACH configuration, a CG configuration (e.g., via an IE cg-SDT-config), configuration(s) for service radio bear (SRB)/data radio bearer (DRB) used for SDT, a DRB list, etc. The SDT configuration may be received via any suitable signaling, such as via an information element (IE) sdt-Config, an IE sdt-ConfigCommon and/or the other RRC IE or message.

In some example embodiments, the terminal device 110 may receive a paging message from the network device 120. The paging message may indicate to the terminal device 110 to initiate a MT-SDT procedure. In other words, the paging message may be used to trigger the MT-SDT procedure. As an example, the paging message may be a message PagingRecord.

Upon trigger of the MT-SDT procedure, for example, in response to receiving the paging message, the RRC entity 130 of the terminal device 110 may indicate (310) first information associated with the MT-SDT procedure to the MAC entity 140 of the terminal device 110.

Based on the first information, the MAC entity 140 may check (315) one or more conditions related to initiation of the MT-SDT procedure, which may be referred to as initiation condition. In other words, the MAC entity may determine whether the one or more initiation conditions are fulfilled. The first information triggers condition checking at the MAC entity 140.

The first information may comprise any suitable indication. In some example embodiments, the first information may include a general indication to check the one or more initiation conditions. For example, the RRC entity 130 may indicate to the MAC entity 140 to check if the MT-SDT procedure can be initiated. In this case, different conditions or different set of conditions than those for the MO-SDT may be checked by the MAC entity 140. For example, the data volume threshold (DVT) may not be checked.

Alternatively, the first information may include a specific indication to check a condition of the one or more initiation conditions. In some example embodiments, the first information may indicate the MAC entity 140 to check the conditions for initiating a SDT procedure via a resource for a CG-SDT procedure, which is also referred to as a CG-SDT resource. For example, the RRC entity 130 may indicate to the MAC entity 140 to check only whether conditions for initiating the SDT procedure via the CG-SDT resource are fulfilled if there is no available UL SDT data for transmission upon initiation of the MT-SDT procedure.

Any suitable condition related to initiation of the MT-SDT procedure may be checked by the MAC entity 140. In some example embodiments, a RSRP threshold condition may be checked. For example, the RSRP threshold condition may include that the RSRP of the downlink pathloss reference is higher than a SDT RSRP threshold (such as, sdt-RSRP-Threshold). If the SDT RSRP threshold is not configured, the RSRP threshold condition may be omitted. In some example embodiments, if the RSRP threshold condition is omitted, conditions for initiating MT-SDT may be always true and the MAC entity 140 may check only which resources are used.

Alternatively, or in addition, in some example embodiments, conditions for initiating the SDT procedure via the CG-SDT resource may be checked. For example, the conditions for initiating the SDT procedure via the CG-SDT resource may include, but not limited to, that the Serving Cell is configured with supplementary uplink, that CG-SDT is configured on the selected UL carrier, and TA for CG-SDT is valid, that at least one SSB configured for CG-SDT with SS-RSRP above cg-SDT-RSRP-ThresholdSSB is available, etc.

Alternatively, or in addition, in some example embodiments, conditions for initiating the SDT procedure via a resource for a RA-SDT procedure (which is also referred to as RA-SDT resource) may be checked. For example, the conditions for initiating the SDT procedure may include, but not limited to, that a set of RA resources for performing RA-SDT are selected on the selected UL carrier.

Alternatively, or in addition, in some example embodiments, conditions for initiating the MT-SDT procedure may be checked. Alternatively, or in addition, in some example embodiments, conditions for initiating the MO-SDT procedure may be checked.

Through checking the one or more initiation conditions, the terminal device 110 may determine whether the MT-SDT procedure can be initiated and what resource can be used if the MT-SDT procedure can be initiated.

Continuing with the signaling chart 300, based on a result of the condition checking, the MAC entity 140 may indicate (320) second information to the RRC entity 130. The second information is related to the result of the condition checking.

In some example embodiments, the MAC entity 140 may indicate to the RRC entity 130 that conditions for initiating the MT-SDT procedure are fulfilled or that the MT-SDT procedure can be initiated, which is also referred to as a general indication. Such a general indication may not include information about what resource can be used. In some example embodiments, the MAC entity 140 may further indicate to the RRC entity 130 of which resource can be used for the MT-SDT procedure, which is also referred to as a specific indication. For example, the MAC entity 140 may indicate to the RRC entity 130 that the conditions for initiating the SDT procedure via the CG-SDT resource are fulfilled. In some example embodiments, the MAC entity 140 may indicate to the RRC entity 130 that some or all of conditions for initiating the MT-SDT procedure are not fulfilled.

Then, the RRC entity 130 may determine (325) whether to initiate the MT-SDT procedure based on the second information. In some example embodiments, the MT-SDT procedure may be initiated for example using the CG-SDT resource or common RA resource. In some other example embodiments, the MT-SDT procedure may not be initiated. Instead, a non-SDT resume procedure or an MO-SDT procedure may be initiated. Then, transmission to the network device 120 may be performed (330). Alternatively, the terminal device 110 may not initiate any procedure to respond to the paging message from the network device 120.

In some example embodiments, if the MAC entity 140 indicates to the RRC entity 130 that conditions for initiating the MT-SDT procedure are fulfilled or that the MT-SDT procedure can be initiated, the RRC entity 130 may just initiate the MT-SDT procedure. The RRC entity 130 may indicate the MAC entity 140 to initiate the MT-SDT procedure and the MAC entity 140 may determine the resource to be used based on the result of the condition checking. For example, if the conditions for initiating the SDT procedure via the CG-SDT resource are fulfilled, the MAC entity 140 may determine to use the CG-SDT resource. For another example, if the conditions for initiating the SDT procedure via the CG-SDT resource are not fulfilled but the RSRP threshold condition is fulfilled, the MAC entity 140 may determine to use the common RA resource.

In some example embodiments, the RRC entity 130 may determine which resource is used for the MT-SDT procedure. In an example, based on the second information from the MAC entity 140, the RRC entity 130 may initiate the MT-SDT procedure using the CG-SDT resource. In another example, based on the second information from the MAC entity 140, the RRC entity 130 may initiate the MT-SDT procedure using the common RA resource. For example, the RRC entity 130 may indicate to the MAC entity 140 to initiate a RA procedure.

An example interaction process between the MAC entity 140 and the RRC entity 130 is described above. Some more example embodiments regarding the condition checking and the interactions are described now.

In some example embodiments, the RSRP threshold condition and/or the conditions for initiating the SDT procedure via the CG-SDT resource may be checked by the MAC entity 140. For example, if the RRC entity 130 indicate to the MAC entity 140 to check if the MT-SDT procedure can be initiated, the MAC entity 140 may only check whether the RSRP threshold condition and/or the conditions for initiating the SDT procedure via the CG-SDT resource are fulfilled.

In some example embodiments, if the conditions for initiating the SDT procedure via the CG-SDT resource are fulfilled, the terminal device 110 may initiate the MT-SDT procedure using the CG-SDT resource. In an example, if the MAC entity 140 determines that the conditions for initiating the SDT procedure via the CG-SDT resource are fulfilled, the MAC entity 140 may indicate to the RRC entity 130 that the conditions for initiating the SDT procedure via the CG-SDT resource are fulfilled. Based on this indication, the RRC entity 130 may determine that MT-SDT procedure can be initiated and the CG-SDT resource can be used. Alternatively, the MAC entity 140 may just indicate to the RRC entity 130 that the conditions for initiating the MT-SDT procedure are fulfilled or that the MT-SDT procedure can be initiated. Accordingly, the RRC entity 130 may just initiate the MT-SDT procedure and then the MAC entity 140 may determine to use the CG-SDT resource for the MT-SDT.

In some example embodiments, if the conditions for initiating the SDT procedure via the CG-SDT resource are not fulfilled and the RSRP threshold condition is fulfilled, the terminal device 110 may initiate the MT-SDT procedure using the common RA resource. In an example, if the MAC entity 140 determines that the conditions for initiating the SDT procedure via the CG-SDT resource are not fulfilled and the RSRP threshold condition is fulfilled, the MAC entity 140 may indicate to the RRC entity 130 at least one of that the conditions for initiating the SDT procedure via the CG-SDT resource are not fulfilled, that the RSRP threshold condition is fulfilled, that the conditions for initiating the MT-SDT procedure are fulfilled, or that the conditions for initiating the SDT procedure are fulfilled. Based on such an indication, the RRC entity 130 may determine that the MT-SDT procedure can be initiated, and the common RA resource can be used. Alternatively, the MAC entity 140 may just indicate to the RRC entity 130 that the conditions for initiating the MT-SDT procedure are fulfilled or that the MT-SDT procedure can be initiated. Accordingly, the RRC entity 130 may just initiate the MT SDT procedure and then the MAC entity 140 may determine to use the common RA resource for the MT-SDT.

In some example embodiments, if the conditions for initiating the SDT procedure via the CG-SDT resource are not fulfilled and the RSRP threshold condition is not fulfilled, the terminal device 110 may initiate a non-SDT RRC resume procedure. In an example, if the MAC entity 140 determines that the conditions for initiating the SDT procedure via the CG-SDT resource are not fulfilled and the RSRP threshold condition is not fulfilled, the MAC entity 140 may indicate to the RRC entity 130 at least one of: that the conditions for initiating the MT-SDT procedure are not fulfilled, or that conditions for initiating the SDT procedure are not fulfilled. Based on this indication, the RRC entity 130 may determine that the MT-SDT procedure cannot be initiated and may initiate the non-SDT RRC resume procedure instead.

In the above-described example embodiments, the conditions for initiating SDT procedure via the CG-SDT resource and/or RSRP threshold condition are checked. Merely as example without any limitation, an example implementation into a technical specification (for example, TS 38.221) may be as below:

The MAC entity may be configured by RRC with SDT and the SDT procedure may be initiated by RRC layer. The SDT procedure can be performed either by Random Access procedure with 2-step RA type or 4-step RA type (i.e., RA-SDT) or by configured grant Type 1 (i.e., CG-SDT).
RRC configures the following parameters for SDT procedure:
sdt-DataVolumeThreshold: data volume threshold for the UE to determine whether to perform SDT procedure;
sdt-RSRP-Threshold: RSRP threshold for UE to determine whether to perform SDT procedure;
cg-SDT-RSRP-ThresholdSSB: an RSRP threshold configured for SSB selection for CG-SDT.
   The MAC entity shall, if initiated by the upper layers for SDT procedure:
1>if the data volume of the pending UL data across all RBs configured for SDT is less than or equal to sdt-Data VolumeThreshold or if the SDT procedure is initiated for MT-SDT; and
NOTE: For SDT procedure, the MAC entity also considers the suspended RBs configured with SDT for data volume calculation. It is up to the UE's implementation how the UE calculates the data volume for the suspended RBs. Size of the CCCH message is not considered for data volume calculation
1>if the RSRP of the downlink pathloss reference is higher than sdt-RSRP-Threshold; or
1>if sdt-RSRP-Threshold is not configured:
   2>if the Serving Cell is configured with supplementary uplink as specified in TS 38.331 [5]; and
   2>if the RSRP of the downlink pathloss reference is less than rsrp-ThresholdSSB-SUL:
      3>select the SUL carrier.
   2>else:
      3>select the NUL carrier.
   2>if CG-SDT is configured on the selected UL carrier, and TA for CG-SDT is valid according to clause 5.27.2 in the first available CG occasion for initial CG-SDT transmission with CCCH message according to clause 5.8.2; and
   2>if, for each RB having data available for transmission, configuredGrantType1Allowed, if configured, is configured with value true for the corresponding logical channel; and
   2>if at least one SSB configured for CG-SDT with SS-RSRP above cg-SDT-RSRP-ThresholdSSB is available:
      3>if the SDT procedure is initiated for MT-SDT by upper layers:
         4>indicate to upper layers that the conditions for initiating CG-SDT procedure are fulfilled.
      3>else:
         4>indicate to the upper layers that the conditions for initiating SDT procedure are fulfilled;
      3>perform CG-SDT procedure on the selected UL carrier according to clause 5.8.2.
   2>else if the SDT procedure is initiated for MT-SDT by upper layers:
      3>indicate to upper layers that the conditions for initiating CG-SDT procedure are not fulfilled OR (alternative) indicate to upper layers that the conditions for initiating SDT procedure are fulfilled OR (alternative) indicate to upper layers that the RSRP of the downlink pathloss reference is higher than sdt-RSRP-Threshold.
   2>else if the SDT procedure is not initiated for MT-SDT by upper layers; and
   2>if a set of Random Access resources for performing RA-SDT are selected according to clause 5.1.1b on the selected UL carrier:
      3>if cg-SDT-TimeAlignmentTimer is running, consider cg-SDT-TimeAlignmentTimer as expired and perform the corresponding actions in clause 5.2;
      3>indicate to the upper layers that the conditions for initiating SDT procedure are fulfilled.
   2>else:
      3>indicate to the upper layers that the conditions for initiating SDT procedure are not fulfilled.
1>else:
   2>indicate to the upper layers that the conditions for initiating SDT procedure are not fulfilled.

Another example implementation into a technical specification (for example, TS 38.331) in terms of conditions for initiating MT-SDT may be as below:

A UE in RRC INACTIVE initiates the resume procedure for MT-SDT when all of the following conditions are fulfilled:
1>PagingRecord includes indication for initiating MT-SDT; and
1>SIBI includes sdt-ConfigCommon; and
1>sdt-Config is configured; and
1>when initiated, lower layers indicate that conditions for initiating MT-SDT as specified in TS 38.321 [3] are fulfilled.

A further example implementation into the technical specification (for example, TS 38.331) in terms of initiation may be as below:

Upon initiation of the procedure, the UE shall:
1>if sdt-MAC-PHY-CG-Config is configured:
   2>if the resume procedure is initiated in a cell that is different to the PCell in which the UE received the stored sdt-MAC-PHY-CG-Config:
      3>release the stored sdt-MAC-PHY-CG-Config;
      3>instruct the MAC entity to stop the cg-SDT-TimeAlignmentTimer, if it is running;
1>if conditions for initiating SDT in accordance with section 5.3.13.1b of TS 38.331 for MO-SDT are fulfilled; or:
1>if conditions for initiating SDT in accordance with section 5.3.13.1c of TS 38.331 for MT-SDT are fulfilled:
   2>consider the resume procedure is initiated for SDT;
   2>if the lower layers indicate that the conditions for initiating CG-SDT procedure are not fulfilled OR (alternative) lower layers indicate that the conditions for initiating SDT procedure are fulfilled OR (alternative) lower layers indicate that the RSRP of the downlink pathloss reference is higher than sdt-RSRP-Threshold:
      3>indicate to lower layers to initiate a Random Access procedure as specified in TS 38.321 [3];
   2>start timer T319a when the lower layers first transmit the CCCH message;
   2>consider SDT procedure is ongoing;
1>else:
   2>start timer T319;
   2>instruct the MAC entity to stop the cg-SDT-TimeAlignmentTimer, if it is running;
1>if ta-Report is configured with value enabled and the UE supports TA reporting:
   2>indicate TA report initiation to lower layers;
1>set the variable pendingRNA-Update to false;
1>release successHO-Config from the UE Inactive AS context, if stored;
1>initiate transmission of the RRCResumeRequest message or RRCResumeRequest1 in accordance with section 5.3.13.3 of TS38.331.

In addition to or as alternative to the conditions for initiating the SDT procedure via the CG-SDT resource and/or the RSRP threshold condition, some other condition may be checked.

In some example embodiments, the conditions for initiating a SDT procedure via the CG-SDT resource, the conditions for initiating the SDT procedure via the RA-SDT resource, and/or UL SDT data may be checked. For example, if the RRC entity 130 indicate to the MAC entity 140 to check if the MT-SDT procedure can be initiated, the MAC entity 140 may check these condition.

In some example embodiments, if the conditions for initiating a SDT procedure via the CG-SDT resource is not fulfilled, the UL SDT data is available and the conditions for initiating the SDT procedure via the RA-SDT resource are fulfilled, the terminal device 110 may initiate the MO-SDT procedure or a non-SDT RRC resume procedure. For example, if the available UL SDT data is associated with a radio bear configured with SDT, the MO-SDT procedure may be initiated. Otherwise, the non-SDT RRC resume procedure may be initiated.

In an example, the RRC entity 130 may indicate to the MAC entity 140 to check whether the MT-SDT can be initiated. Based on this indication, the MAC entity 140 may check whether the conditions for initiating the SDT procedure via the CG-SDT resource is fulfilled. If the conditions for initiating the SDT procedure via the CG-SDT resource are not fulfilled, the MAC entity 140 may determine whether there is UL SDT data available for transmission. If there is UL SDT data available for transmission, the MAC entity 140 may checks whether the conditions for initiating the SDT procedure via the RA-SDT resource are fulfilled. If the conditions for initiating the SDT procedure via the RA-SDT resource are fulfilled, the MAC entity 140 may indicate to the RRC entity 130 that the conditions for initiating the SDT procedure via the RA-SDT resource are fulfilled or the conditions for initiating the MO-SDT procedure are fulfilled.

Based on this indication from the MAC entity 140, the RRC entity 130 may determine that the MT-SDT procedure cannot be initiated but MO-SDT procedure can be initiated. The RRC entity 130 may initiate either the MO-SDT procedure or the non-SDT RRC Resume procedure.

In such example embodiments, the MO-SDT can be triggered instead of the MT-SDT in case there is UL SDT data available.

In some example embodiments, a specific condition may be checked. As an example, only the conditions for initiating the SDT procedure via the CG-SDT resource may be checked. For example, if there is no available UL SDT data for transmission upon initiation of the MT-SDT procedure, the RRC entity 130 may indicate to the MAC entity 140 to check only whether the conditions for initiating the SDT procedure via the CG-SDT resource are fulfilled. If the conditions for initiating the SDT procedure via the CG-SDT resource are fulfilled, the terminal device 110 may initiate the MT-SDT procedure using the CG-SDT resource. For example, the MAC entity 140 may indicate to the RRC entity 130 that the conditions for initiating the SDT procedure via the CG-SDT resource are fulfilled or that the conditions for initiating the MT-SDT procedure are fulfilled. Accordingly, the RRC entity 130 may initiate the MT-SDT procedure and the CG-SDT resource is used.

In some example embodiments, if the conditions for initiating the SDT procedure via the CG-SDT resource are not fulfilled, the terminal device 110 may initiate the non-SDT RRC resume procedure. For example, the MAC entity 140 may indicate to the RRC entity 130 that the conditions for initiating the SDT procedure via the CG-SDT resource are not fulfilled or that the conditions for initiating the MT-SDT procedure are not fulfilled. Accordingly, the RRC entity 130 may determine that the MT-SDT procedure cannot be initiated and may initiate the non-SDT RRC resume procedure instead.

Alternatively, in some example embodiments, even though the RRC entity 130 indicates to the MAC entity 140 to check a specific condition, the MAC entity 140 may also check one or more other conditions. Based on the result of the condition checking, the MAC entity 140 may indicate to the RRC entity 130 whether the specific condition is fulfilled, or whether the one or more other conditions are fulfilled, or whether the conditions for initiating the MT-SDT procedure are fulfilled. Based on this indication from the MAC entity 140, the RRC entity 130 may determine whether to initiate the Mt-SDT procedure.

As an example, the RRC entity 130 may indicate to the MAC entity 140 to check the conditions for initiating the SDT procedure via the CG-SDT resource. The MAC entity 140 may also check one or more other conditions, for example, the RSRP threshold condition. Then, based on the result of the condition checking, the MAC entity 140 may indicate to the RRC entity 130 whether the conditions for initiating the SDT procedure via the CG-SDT resource, or whether the RSRP threshold condition is fulfilled, or whether the conditions for initiating the MT-SDT procedure are fulfilled.

Through the condition checking and the interactions between the RRC and MAC layers, a correct initiation of the MT-SDT procedure can be achieved. Moreover, it is noted that the combination of different conditions described above is illustrated as example without limitation.

In FIG. 3, only one RRC entity 130 and one MAC entity 140 are depicted but more than one RRC and/or MAC entities may be included in the terminal device 110.

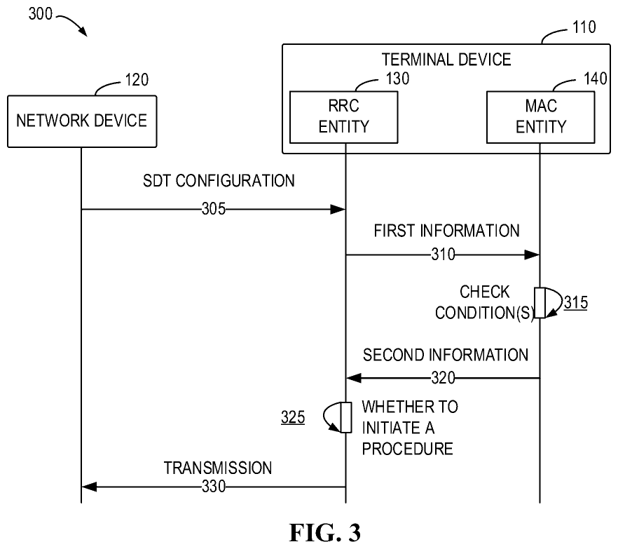

FIG. 4 shows a flowchart of an example method 400 implemented at a terminal device in accordance with some example embodiments of the present disclosure. For the purpose of discussion, the method 400 will be described from the perspective of the terminal device 110 in FIG. 1.

At block 410, a RRC entity of the terminal device indicates, to a MAC entity of the terminal device, first information associated with a MT-SDT procedure.

At block 420, the MAC entity determines whether one or more conditions related to initiation of the MT-SDT procedure are fulfilled based on the first information.

At block 430, the MAC entity indicates, to the RRC entity, second information based on the determination.

At block 440, the RRC entity determines whether to initiate the MT-SDT procedure based on the second information.

In some example embodiments, the one or more conditions include at least one of: a reference signal received power, RSRP, threshold condition, conditions for initiating the MT-SDT procedure, conditions for initiating a small data transmission, SDT, procedure via a resource for a configured grant small data transmission, CG-SDT, procedure, conditions for initiating the SDT procedure via a resource for random access small data transmission, RA-SDT, procedure, or conditions for initiating a mobile oriented small data transmission, MO-SDT, procedure.

In some example embodiments, the terminal device may initiate the MT-SDT procedure using the resource for the CG-SDT procedure if the conditions for initiating the SDT procedure via the resource for the CG-SDT procedure are fulfilled.

In some example embodiments, the second information indicates that the conditions for initiating the SDT procedure via the resource for the CG SDT procedure are fulfilled.

In some example embodiments, the terminal device may initiate the MT-SDT procedure using a resource for a common random access, RA, procedure if the conditions for initiating the SDT procedure via the resource for the CG-SDT procedure are not fulfilled, and the RSRP threshold condition is fulfilled.

In some example embodiments, the second information indicates at least one of: that the conditions for initiating the SDT procedure via the resource for the CG SDT procedure are not fulfilled, that the RSRP threshold condition is fulfilled, that the conditions for initiating the MT-SDT procedure are fulfilled, or that conditions for initiating the SDT procedure are fulfilled.

In some example embodiments, the terminal device may initiate a non-SDT RRC resume procedure if the conditions for initiating the SDT procedure via the resource for the CG-SDT procedure are not fulfilled, and the RSRP threshold condition is not fulfilled.

In some example embodiments, the second information indicates at least one of: that the conditions for initiating the MT-SDT procedure are not fulfilled, or that conditions for initiating the SDT procedure are not fulfilled.

In some example embodiments, the terminal device may initiate the MO-SDT procedure or a non-SDT RRC resume procedure if: the conditions for initiating the SDT procedure via the resource for the CG SDT procedure are not fulfilled, uplink small data transmission data is available, and the conditions for initiating the SDT procedure via the resource for the RA SDT procedure are fulfilled.

In some example embodiments, the second information indicates at least one of: that the conditions for initiating the SDT procedure via the resource for the RA SDT procedure are fulfilled, or that the conditions for initiating the MO SDT procedure are fulfilled.

In some example embodiments, the first information indicates to check only the conditions for initiating a SDT procedure via a resource for a CG-SDT procedure if no uplink SDT data is available for transmission of the MT-SDT procedure.

In some example embodiments, an apparatus capable of performing any of the method 400 (for example, the terminal device 110 in FIG. 1) may comprise means for performing the respective operations of the method 400. The means may be implemented in any suitable form. For example, the means may be implemented in a circuitry or software module. The apparatus may be implemented as or included in the terminal device 110 in FIG. 1.

In some example embodiments, the apparatus comprises means for indicating, by a radio resource control, RRC, entity of the apparatus to a medium access control, MAC, entity of the apparatus, first information associated with a mobile terminated small data transmission, MT-SDT, procedure; means for determining, by the MAC entity, whether one or more conditions related to initiation of the MT-SDT procedure are fulfilled based on the first information; means for indicating, by the MAC entity to the RRC entity, second information based on the determination; and means for determining, by the RRC entity, whether to initiate the MT-SDT procedure based on the second information.

In some example embodiments, the one or more conditions include at least one of: a reference signal received power, RSRP, threshold condition, conditions for initiating the MT-SDT procedure, conditions for initiating a small data transmission, SDT, procedure via a resource for a configured grant small data transmission, CG-SDT, procedure, conditions for initiating the SDT procedure via a resource for random access small data transmission, RA-SDT, procedure, or conditions for initiating a mobile oriented small data transmission, MO-SDT, procedure.

In some example embodiments, the apparatus comprises: means for initiating the MT-SDT procedure using the resource for the CG-SDT procedure if the conditions for initiating the SDT procedure via the resource for the CG-SDT procedure are fulfilled.

In some example embodiments, the second information indicates that the conditions for initiating the SDT procedure via the resource for the CG SDT procedure are fulfilled.

In some example embodiments, the apparatus comprises: means for initiating the MT-SDT procedure using a resource for a common random access, RA, procedure if the conditions for initiating the SDT procedure via the resource for the CG-SDT procedure are not fulfilled, and the RSRP threshold condition is fulfilled.

In some example embodiments, the second information indicates at least one of: that the conditions for initiating the SDT procedure via the resource for the CG SDT procedure are not fulfilled, that the RSRP threshold condition is fulfilled, that the conditions for initiating the MT-SDT procedure are fulfilled, or that conditions for initiating the SDT procedure are fulfilled.

In some example embodiments, the apparatus comprises: means for initiating a non-SDT RRC resume procedure if the conditions for initiating the SDT procedure via the resource for the CG-SDT procedure are not fulfilled, and the RSRP threshold condition is not fulfilled.

In some example embodiments, the second information indicates at least one of: that the conditions for initiating the MT-SDT procedure are not fulfilled, or that conditions for initiating the SDT procedure are not fulfilled.

In some example embodiments, the apparatus comprises: means for initiating the MO-SDT procedure or a non-SDT RRC resume procedure if: the conditions for initiating the SDT procedure via the resource for the CG SDT procedure are not fulfilled, uplink small data transmission data is available, and the conditions for initiating the SDT procedure via the resource for the RA SDT procedure are fulfilled.

In some example embodiments, the second information indicates at least one of: that the conditions for initiating the SDT procedure via the resource for the RA SDT procedure are fulfilled, or that the conditions for initiating the MO SDT procedure are fulfilled.

In some example embodiments, the first information indicates to check only the conditions for initiating a SDT procedure via a resource for a CG-SDT procedure if no uplink SDT data is available for transmission of the MT-SDT procedure.

In some example embodiments, the apparatus further comprises means for performing other operations in some example embodiments of the method 400 or the terminal device 110. In some example embodiments, the means comprises at least one processor; and at least one memory storing instructions that, when executed by the at least one processor, cause the performance of the apparatus.

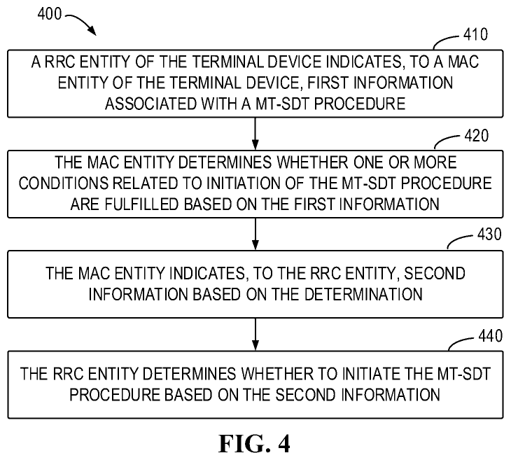

FIG. 5 is a simplified block diagram of a device 500 that is suitable for implementing example embodiments of the present disclosure. The device 500 may be provided to implement a communication device, for example, the terminal device 110 or the network device 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The instructions of the program 530 may include instructions for performing operations/acts of some example embodiments of the present disclosure. The program 530 may be stored in the memory, e.g., the ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIG. 2A to FIG. 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

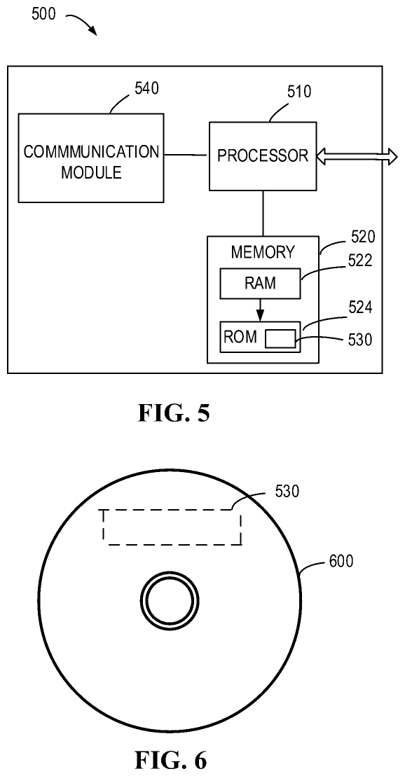

FIG. 6 shows an example of the computer readable medium 600 which may be in form of CD, DVD or other optical storage disk. The computer readable medium 600 has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-24. (canceled)

25. An apparatus comprising:
at least one processor; and
at least one memory storing instructions that, when executed by the at least one processor, cause the apparatus at least to:
indicate, by a radio resource control (RRC) entity of the apparatus to a medium access control (MAC) entity of the apparatus, first information associated with a mobile terminated small data transmission (MT-SDT) procedure;
determine, by the MAC entity, whether one or more conditions related to initiation of the MT-SDT procedure are fulfilled based on the first information;
indicate, by the MAC entity to the RRC entity, second information based on the determination; and
determine, by the RRC entity, whether to initiate the MT-SDT procedure based on the second information.

26. The apparatus of claim 25, wherein the one or more conditions include at least one of:
a reference signal received power (RSRP) threshold condition,
conditions for initiating the MT-SDT procedure,
conditions for initiating a small data transmission (SDT) procedure via a resource for a configured grant small data transmission (CG-SDT) procedure,
conditions for initiating the SDT procedure via a resource for random access small data transmission (RA-SDT) procedure, or
conditions for initiating a mobile oriented small data transmission (MO-SDT) procedure.

27. The apparatus of claim 26, wherein the at least one memory storing instructions that, when executed by the at least one processor, cause the apparatus to:
initiate the MT-SDT procedure using the resource for the CG-SDT procedure if the conditions for initiating the SDT procedure via the resource for the CG-SDT procedure are fulfilled.

28. The apparatus of claim 26, wherein the at least one memory storing instructions that, when executed by the at least one processor, cause the apparatus to:
initiate the MT-SDT procedure using a resource for a common random access, RA, procedure if the conditions for initiating the SDT procedure via the resource for the CG-SDT procedure are not fulfilled, and the RSRP threshold condition is fulfilled.

29. The apparatus of claim 28, wherein the second information indicates at least one of:
that the conditions for initiating the SDT procedure via the resource for the CG-SDT procedure are not fulfilled,
that the RSRP threshold condition is fulfilled,
that the conditions for initiating the MT-SDT procedure are fulfilled, or
that conditions for initiating the SDT procedure are fulfilled.

30. The apparatus of claim 26, wherein the at least one memory storing instructions that, when executed by the at least one processor, cause the apparatus to:
initiate a non-SDT RRC resume procedure if the conditions for initiating the SDT procedure via the resource for the CG-SDT procedure are not fulfilled, and the RSRP threshold condition is not fulfilled.

31. The apparatus of claim 30, wherein the second information indicates at least one of:
that the conditions for initiating the MT-SDT procedure are not fulfilled, or
that conditions for initiating the SDT procedure are not fulfilled.

32. A method comprising:
indicating, by a radio resource control (RRC) entity of a terminal device to a medium access control (MAC) entity of the terminal device, first information associated with a mobile terminated small data transmission (MT-SDT) procedure;
determining, by the MAC entity, whether one or more conditions related to initiation of the MT-SDT procedure are fulfilled based on the first information;
indicating, by the MAC entity to the RRC entity, second information based on the determination; and
determining, by the RRC entity, whether to initiate the MT-SDT procedure based on the second information.

33. The method of claim 32, wherein the one or more conditions include at least one of:
a reference signal received power (RSRP) threshold condition,
conditions for initiating the MT-SDT procedure,
conditions for initiating a small data transmission (SDT) procedure via a resource for a configured grant small data transmission (CG-SDT) procedure,
conditions for initiating the SDT procedure via a resource for random access small data transmission (RA-SDT) procedure, or
conditions for initiating a mobile oriented small data transmission (MO-SDT) procedure.

34. The method of claim 33, further comprising:
initiating the MT-SDT procedure using the resource for the CG-SDT procedure if the conditions for initiating the SDT procedure via the resource for the CG-SDT procedure are fulfilled.

35. The method of claim 33, further comprising:
initiating the MT-SDT procedure using a resource for a common random access, RA, procedure if the conditions for initiating the SDT procedure via the resource for the CG-SDT procedure are not fulfilled, and the RSRP threshold condition is fulfilled.

36. The method of claim 35, wherein the second information indicates at least one of:
that the conditions for initiating the SDT procedure via the resource for the CG-SDT procedure are not fulfilled,
that the RSRP threshold condition is fulfilled,
that the conditions for initiating the MT-SDT procedure are fulfilled, or
that conditions for initiating the SDT procedure are fulfilled.

37. The method of claim 33, further comprising:
initiating a non-SDT RRC resume procedure if the conditions for initiating the SDT procedure via the resource for the CG-SDT procedure are not fulfilled, and the RSRP threshold condition is not fulfilled.

38. The method of claim 37, wherein the second information indicates at least one of:
that the conditions for initiating the MT-SDT procedure are not fulfilled, or
that conditions for initiating the SDT procedure are not fulfilled.

39. A non-transitory computer readable medium comprising instructions stored thereon for causing an apparatus at least to perform:
indicating, by a radio resource control (RRC) entity of the apparatus to a medium access control (MAC) entity of the apparatus, first information associated with a mobile terminated small data transmission (MT-SDT) procedure;
determining, by the MAC entity, whether one or more conditions related to initiation of the MT-SDT procedure are fulfilled based on the first information;
indicating, by the MAC entity to the RRC entity, second information based on the determination; and
determining, by the RRC entity, whether to initiate the MT-SDT procedure based on the second information.

40. The non-transitory computer readable medium of claim 39, wherein the one or more conditions include at least one of:
a reference signal received power (RSRP) threshold condition,
conditions for initiating the MT-SDT procedure,
conditions for initiating a small data transmission (SDT) procedure via a resource for a configured grant small data transmission (CG-SDT) procedure,
conditions for initiating the SDT procedure via a resource for random access small data transmission (RA-SDT) procedure, or
conditions for initiating a mobile oriented small data transmission (MO-SDT) procedure.

41. The non-transitory computer readable medium of claim 40, further comprising instructions for causing the apparatus for:
initiating the MT-SDT procedure using the resource for the CG-SDT procedure if the conditions for initiating the SDT procedure via the resource for the CG-SDT procedure are fulfilled.

42. The non-transitory computer readable medium of claim 40, further comprising instructions for causing the apparatus for:
initiating the MT-SDT procedure using a resource for a common random access, RA, procedure if the conditions for initiating the SDT procedure via the resource for the CG-SDT procedure are not fulfilled, and the RSRP threshold condition is fulfilled.

43. The non-transitory computer readable medium of claim 42, wherein the second information indicates at least one of:
that the conditions for initiating the SDT procedure via the resource for the CG-SDT procedure are not fulfilled,
that the RSRP threshold condition is fulfilled,
that the conditions for initiating the MT-SDT procedure are fulfilled, or
that conditions for initiating the SDT procedure are fulfilled.

44. The non-transitory computer readable medium of claim 40, further comprising instructions for causing the apparatus for:
initiating a non-SDT RRC resume procedure if the conditions for initiating the SDT procedure via the resource for the CG-SDT procedure are not fulfilled, and the RSRP threshold condition is not fulfilled.
